(19) United States
(12) Patent Application Publication
(10) Pub. No.: US 2015/0079970 A1
(43) Pub. Date: Mar. 19, 2015

(54) DEFINING A PERIMETER TO MONITOR A WIRELESS DEVICE FOR A VIOLATION OF THE PERIMETER

(71) Applicants: Allan Delgado Campos, San Jose (CR); Fabiel Zuniga Gallegos, Roseville, CA (US); Daniel E. Ford, Seattle, WA (US)

(72) Inventors: Allan Delgado Campos, San Jose (CR); Fabiel Zuniga Gallegos, Roseville, CA (US); Daniel E. Ford, Seattle, WA (US)

(21) Appl. No.: 14/387,544

(22) PCT Filed: Mar. 30, 2012
(86) PCT No.: PCT/US2012/031570

§ 371 Date: Sep. 23, 2014

(51) Int. Cl. H04W 4/02; H04W 8/08; H04W 64/00

(52) U.S. Cl. CPC H04W 4/02; H04W 64/00; H04W 8/08
USPC 455/421; 455/456.1

(57) ABSTRACT

Examples disclose a storage medium encoded with instructions executable by a processor of a computing device, the instructions to define a perimeter within a wireless network to monitor a wireless device for violation of the perimeter. Further, the examples provide the instructions to receive a signal data associated with the wireless device. Additionally, the examples also disclose the instructions to detect a location of the wireless device based on the signal data to determine whether the wireless device has violated the defined perimeter.

### BACKGROUND

For security and networking reasons, a wireless device may be monitored to track its locations across various networks. The wireless device may be tracked using signals to locate its respective position.

### BRIEF DESCRIPTION OF THE DRAWINGS

In the accompanying drawings, like numerals refer to like components or blocks. The following detailed description references the drawings, wherein:

FIG. 1 is a block diagram of an example computing system including a defined perimeter and wireless device within a wireless network to transmit signal data to a computing device to monitor whether the wireless device has violated the perimeter;

FIG. 2 is a block diagram of an example computing system including a wireless network with a defined perimeter and wireless device to transmit a signal to wireless access point which transmits signal data to a computing device;

FIG. 3 is a block diagram of an example wireless network illustrating a logical model of a physical site to define a perimeter to monitor a wireless device and including a wireless access point;

FIG. 4 is a block diagram of a computing device to define a perimeter within a wireless network to monitor a wireless device and detect a location of the wireless device to determine whether the wireless device has violated the defined perimeter to transmit a notification and trigger an event; and

FIG. 5 is a flowchart of an example method performed on a computing device to define a perimeter to monitor a wireless device and receive signal data to detect a location of the wireless device and based on a violation of the perimeter, transmit a notification and trigger an event.

### DETAILED DESCRIPTION

Using signals, a position of a wireless device is estimated to determine its location. One solution is to monitor the wireless device using a global positioning system (GPS). GPS uses a satellite type system to determine and track a location of the wireless device. However, this solution does not provide flexibility in defining a specific area through which the wireless device may be restricted. Rather, this solution tracks the wireless device without regards to a restricted area. Further, this solution may provide no mechanism to alert or take action when the wireless device has moved out of the specific area.

In another solution, the wireless device may be monitored using radio-frequency (RF) technology. In this solution, RF signals are transmitted and received to locate the wireless device. However, the device needs to be tagged with specialized equipment in order to track its location.

To address these issues, example embodiments disclosed herein provide a computing device with a processor to define a perimeter within a wireless network to monitor a wireless device for a violation of the perimeter. The violation of the perimeter may be moving outside of or entering the perimeter. This allows the perimeter to be defined by an administrator in a flexible manner to restrict an area of movement for the wireless device. Further, this area restriction allows the administrator to manage the wireless device within an area of shared resources. For example, there may be an area of space shared among multiple people and devices and as such, monitoring a selected wireless device enables a management of that device within that shared area. In a further example, there may be an area on which to restrict access of a wireless device for security reasons, etc.

Additionally, the processor receives signal data associated with the wireless device to detect a location of the wireless device to determine whether it has violated the defined perimeter. In this embodiment, no special equipment is needed in order to tag the wireless device. Further, determining whether the wireless device has moved outside or inside of the defined perimeter, enables the wireless device to be monitored within a shared area, track a borrowed wireless device, and/or provide a security feature. For example, the violation of the perimeter may include the wireless device entering a perimeter, such as in a high security area or from moving outside of the perimeter.

In another embodiment, the computing device transmits a notification the wireless device has violated the perimeter. In this embodiment, an administrator of a borrowed wireless device or wireless device within a shared area may be apprised of security issues involving the wireless device. This also provides a management of the wireless device to monitor the wireless device to ensure it is within a specified area. Thus, the appropriate steps may be taken when the wireless device is outside of or entering a defined perimeter.

In a further embodiment, the notification includes at least one of an email, visual representation, text message, and/or administrator-configured option. This provides an informative communication to the administrator or other users tracking the location of the wireless device, the device has violated the perimeter. Further, enabling the notification to be communicated in various manners provides a flexible and efficient manner the violation may be communicated.

Yet, in a further embodiment, the computing device triggers an event based on whether the wireless has violated the perimeter. The event may include a denial of access to the wireless device for service within the wireless network and/or disable functionality on the wireless device. In this embodiment, the computing device triggers an action in response to the wireless device violation the perimeter. This provides an additional security feature to ensure the wireless device may remain within the defined perimeter. Further, in this embodiment, the event may be dependent on the type of wireless device. For example, a wireless device may be managed and controlled within wireless network, such as a wireless access point (WAP), thus the trigger may disable the functionality of that WAP. In a further example, the wireless device may be a personal device, thus the service to access within the wireless network may be denied.

In summary, example embodiments disclosed herein provide a flexible manner to define a perimeter to restrict an area of movement for the wireless device. This provides an administrator the ability to manage, monitor, and track a wireless device within a restricted area and/or track a borrowed wireless device. Further, it also provides a trigger event and/or notification device as an additional security feature to alert and/or provide an action the wireless device has violated the defined perimeter.

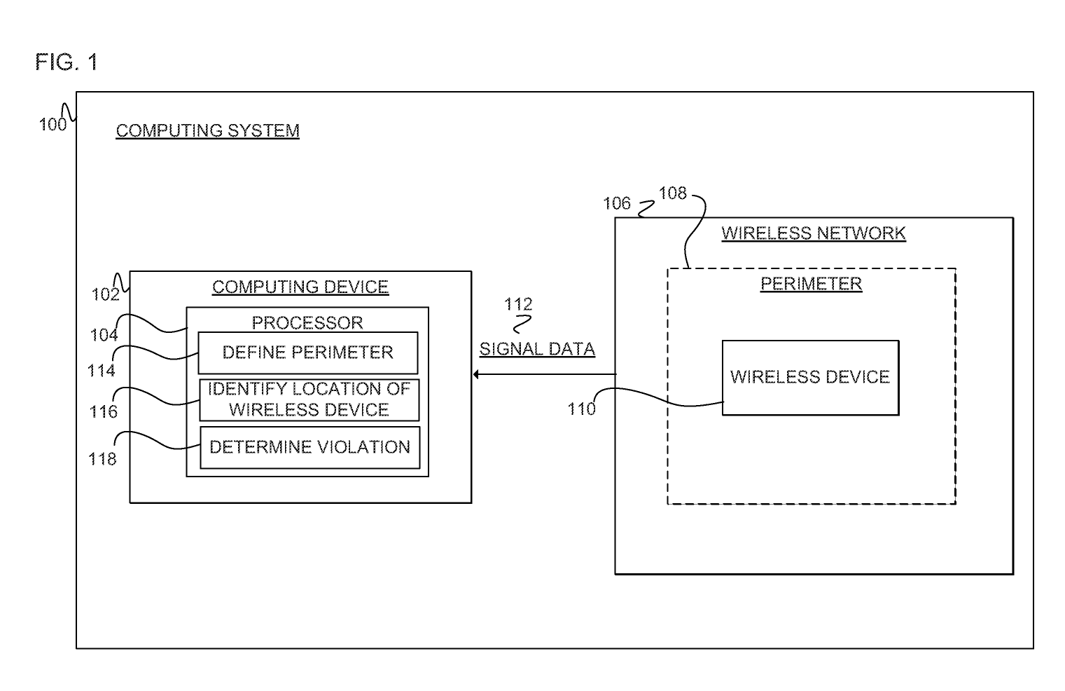

Referring now to the drawings, FIG. 1 is a block diagram of an example computing system 100 including a wireless network 106 with a perimeter 108 and wireless device 110 to transmit signal data 112 to a computing device 102. The computing device 102 includes a processor 104 to define the perimeter 108 at module 114, receive the signal data 112, identify a location of the wireless device 110 based on the signal data 112 at module 116, and determine whether the wireless device 110 has violated the perimeter 108 at module 118. Embodiments of the computing system 100 include a server, a network computing system, or other computing system including the computing device 102 and wireless network 106.

The wireless network 106 includes the perimeter 108 and the wireless device 110. The wireless network 106 may include more than one wireless device 110 interconnected by communication channels as to enable sharing of communication resources and information. Embodiments of the wireless network 106 include a wide area network (WAN), local area network (LAN), personal area network (PAN), mesh network, mobile device network, or other wireless network capable of including the perimeter 108 to monitor the wireless device 110.

The perimeter 108 is a specific area of the wireless network that is a physical location of which to monitor whether the wireless device 110 is violating this perimeter 108. Additionally, although FIG. 1 depicts the perimeter 108 as centered in the wireless network 106, embodiments should not be limited to this illustration as the perimeter may be located anywhere within the wireless network 106, as indicated with a dotted line. In one embodiment, the perimeter 108 is defined by a set of coordinates. In another embodiment, the perimeter is defined by an administrator. In this embodiment, the administrator may define the location of the perimeter 108 on the computing device 102 through a visual mapping illustration. The computing device 102 may store this perimeter 108 in a storage area and use it to compare the location of the wireless device 110 as to determine whether the wireless device 110 is located within or moving outside of the perimeter 108. Additionally, the perimeter 108 may be a small area or encompass the full wireless network. This provides an area restriction and tracking when the wireless device 110 should be stationary, move within a small area within the wireless network 106, restricted from an area, or move within the full wireless network 106.

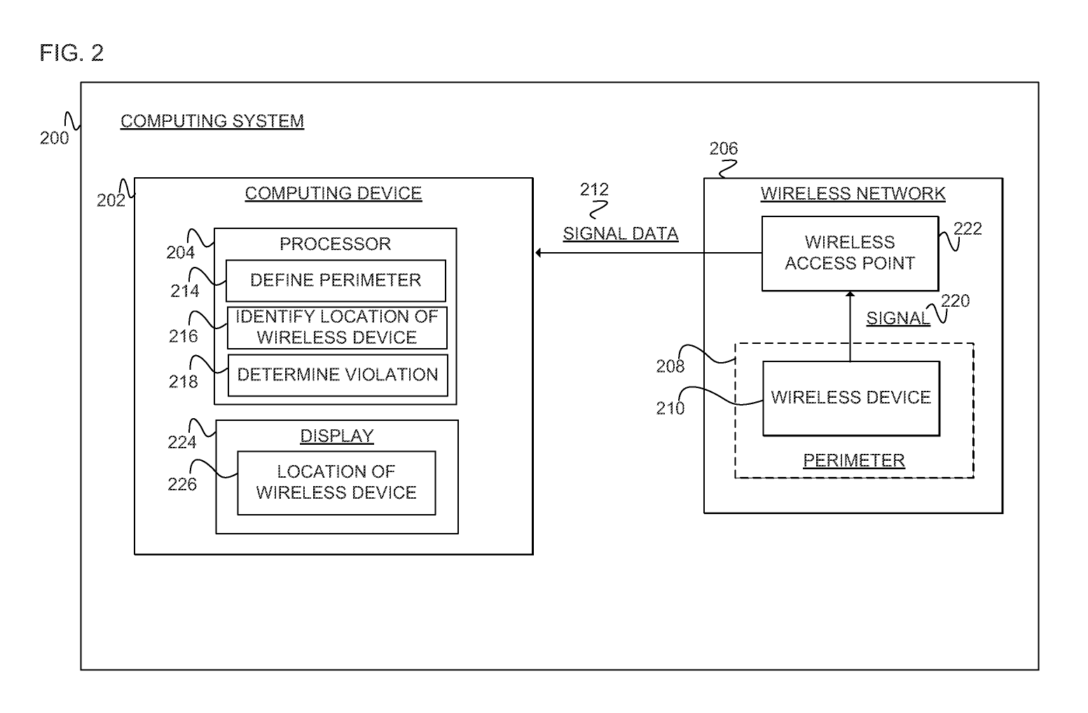

The wireless device 110 is an electronic device that may be monitored as to track its position or location within or outside of the wireless network 108. In one embodiment, the wireless device 110 transmits a signal to a wireless access point within the wireless network 106 which transmits signal data 112 to the computing device 102. In this embodiment, the wireless access point receives the signal from the wireless device 110 and converts the signal into a signal strength value as part of the signal data 112. Further, in this embodiment, the computing device 102 receives the signal data 112 including the signal strength value and converts this value into coordinates. These coordinates identify the location of the wireless device 110. This embodiment is detailed in FIG. 2. In another embodiment, the wireless device 110 may transmit the signal as part of the signal data 112 to the computing device 102. In a further embodiment, the wireless device 110 may be selectively monitored, such as an administrator requesting to locate the wireless device 110. In this embodiment, selectively monitoring the wireless device 110 allows the wireless device 110 to be monitored in a shared area and/or monitoring a borrowed device. Further, although FIG. 1 depicts the wireless device 110 as within the perimeter 108 this was done for illustration purposes and not to limit embodiments. For example, the wireless device may be located outside of the wireless network 106 or elsewhere. Embodiments of the wireless device 110 include a client device, personal computer, desktop computer, laptop, mobile device, tablet, printer, wireless access point (WAP), electronic device, or other wireless device 110 capable of transmitting a signal to determine its location.

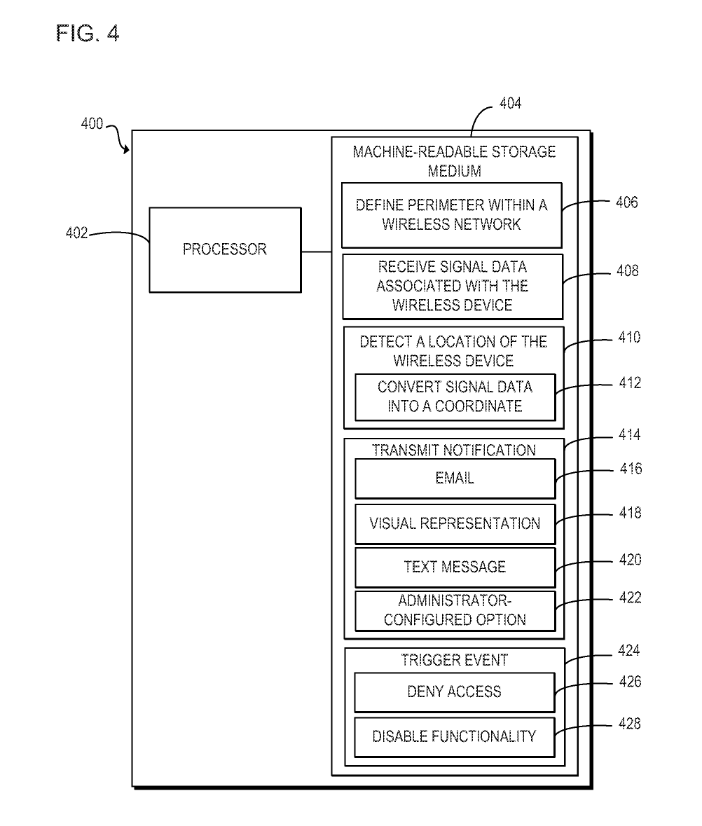

The signal data 112 is transmitted to the computing device 102 with the processor 104. Specifically, the signal data 112 includes data associated with the wireless device which enables the processor at module 116 to identify the location of the wireless device 110. In one embodiment, the wireless device 110 transmits a signal to a wireless access point which may transmit the signal data 112 to the computing device 102. This is explained in detail in later figures. In another embodiment, the signal data 112 may include a signal from the wireless device 110. The difference between the signal and the signal data 112 depends on whether there is a wireless access point in communication with the computing device 102. For example, if the wireless access point may transmit the signal data to the computing device 102 while the wireless device may transmit the signal to the computing device 102. Embodiments of the signal data 112 include coordinates, signal strength, signal frequency, signal timing or other type of signal data associated with the wireless device 110 to identify its location. In one embodiment, the signal data 112 is converted into coordinates. This embodiment is detailed later in FIG. 4.

The computing device 102 receives the signal data 112. Embodiments of the computing device 102 include a client device, personal computer, desktop computer, laptop, a mobile device, a tablet, or other computing device suitable to receive the signal data 112 to determine the location of the wireless device 110.

The processor 104 defines the perimeter 108 within the wireless network 106 at module 114, receives the signal data 112 associated with the wireless device 110 to identify its location at module 116 and determines whether the location violates the perimeter 108 at module 118. Embodiments of the processor 104 include a microchip, chipset, electronic circuit, microprocessor, semiconductor, microcontroller, central processing unit (CPU), graphics processing unit (GPU), visual processing unit (VPU), or other programmable device capable of receiving the signal data 112 to identify a location of the wireless device at module 116 and determine whether the wireless device has violated the perimeter at module 118.

The module 114 defines the perimeter 108 within the wireless network 106. Further, the perimeter 108 is the area of the wireless network 106 that is monitored for when the wireless device 110 is violating this perimeter 108. In this embodiment, the violation is defined. For example, this violation may include the wireless device 110 moving outside of the perimeter 108 or may include the wireless device 110 moving into the perimeter 108. In one embodiment, the module 114 utilizes coordinates to define the perimeter 108, these coordinates may be used to determine whether the location of the wireless device 110 is in violation of the perimeter 108. In another embodiment, module 114 and module 116 are combined to identify the location of the wireless device 110 to determine whether the wireless device 110 is in violation of the perimeter 108 as detailed in later figures. Embodiments of the module 114 include a set of instructions executable by the processor 104, firmware, software, or other instruction set capable of defining the perimeter 108.

The module 116 identifies a location of the wireless device 110. Specifically, once receiving the signal data 112, the processor 104 is able to identify the location of the wireless device 110. In this embodiment, the module 116 may determine the location of the wireless device 110 from signal strength. Analyzing the signal strength, the processor 104 may determine whether the wireless device 110 is within or outside the wireless network 106. Thus, at module 116, the processor may determine the location of the wireless device 110, not necessarily as only within the wireless network 106. Embodiments of the module 116 include a set of instructions executable by the processor 104, firmware, software, or other instruction set capable of identifying the location of the wireless device 110.

The module 118 determines whether the wireless device 110 has violated the defined perimeter 108. The violation of the perimeter 108 includes whether the wireless device is moving into or outside of the perimeter 108. Embodiments of the module 118 include a set of instructions executable by the processor 104, firmware, software, or other instruction set capable of determining whether the wireless device 110 has violated the perimeter 108. In one embodiment of module 118, a notification is transmitted of the violation while in another embodiment, an event is triggered to disable service to the wireless network 106 or functionality of the wireless device 110. These embodiments are detailed in FIG. 4.

FIG. 2 is a block diagram of an example computing system 200 including a wireless network 206 with a perimeter 208 and a wireless device 210 to transmit a signal 220 to a wireless access point 222. Additionally, the wireless access point 222 transmits a signal data 212 to a computing device 202. The computing device 202 includes a processor 204 to execute modules 214-218 and a display 224 to render a location of the wireless device 210 at module 226. The computing device 202, the wireless network 206, and the perimeter 208 may be similar in structure and functionality of the computing device 100 and the wireless network 106 as in FIG. 1, respectively.

The perimeter 208 and the wireless device 210 are included within the wireless network 206. The wireless device 210 transmits the signal 220 to the wireless access point 222. The perimeter 208 and the wireless device 210 may be similar in structure and functionality of the perimeter 108 and the wireless device 110 as in FIG. 1.

The signal 220 is a transmission of data that may include quantities in time and/or spatial sequence from the wireless device 210 to the wireless access point 222 as to identify the location of the wireless device 210. Specifically, the signal 220 includes the signal data 212 that may be encoded or decoded at the wireless access point. In another embodiment, the signal 220 is sent periodically, while in another embodiment, the signal 220 is transmitted when a network administrator may request the location of the wireless device 210. Embodiments of the signal 220 include a radio-frequency (RF) signal, vector signal, analog signal, digital signal, or other type of signal capable of conveying the location of the wireless device 210.

The wireless access point 222 receives the signal 220 from the wireless device 210 and transmits the signal data 212 to the computing device 202. The wireless access point 222 (WAP) is a device which enables the wireless device 210 to connect to the wireless network 206 for services such as telecommunication service and/or Internet service. In one embodiment, the wireless access point 222 receives the signal 220 and converts the signal 220 into a signal strength value which is transmitted at the signal data 212 to the computing device 202. The computing device 202 uses the signal strength value to convert to coordinates to locate the position of the wireless device 210.

The signal data 212 is transmitted from the wireless access point 222 once receiving the signal 220. The signal data 212 may be encoded or decoded to convey information of the location of the wireless device 210. The signal data 212 may be similar in functionality of the signal data 112 as in FIG. 1.

The computing device 202 and the processor 204 receive the signal data 212 from the wireless access point 222. The computing device 202 and the processor 204 may be similar in structure and functionality of the computing device 102 and the processor 104 as in FIG. 1.

The module 214 defines the perimeter 208 in the wireless network 206. Once the processor 204 receives the signal data 212, the module 216 identifies the location of the wireless device 210. In this embodiment, the signal data 212 includes a signal strength value so the processor 204 may determine whether the wireless device 210 is within or outside of the wireless network 206. For example, the signal strength value may be weaker the further away from the wireless access point 222, while the stronger the signal strength the closer the wireless device 210 is to the wireless access point 222. Once identifying the location of the wireless device at module 216, the module 218 then determines whether the wireless device 210 has violated the perimeter 208 as defined at module 214. The modules 214-218 may be similar in functionality of the modules 114-118 as in FIG. 1.

The display 224 renders the location of the wireless device 210 at module 226. Rendering the location of the wireless device 210 enables an administrator to view a visual representation of this location. Embodiments of the display 224 include a computing screen, computing monitor, panel, plasma screen, liquid crystal display (LCD), thin film, projection, or other display technology capable of rendering the location of the wireless device at module 226.

The module 226 renders the location of the wireless device 210 on the display 224. Embodiments of the module 226 include a set of instructions executable by the processor 204, firmware, software, or other instruction set capable of rendering the location of the wireless device on the display 224.

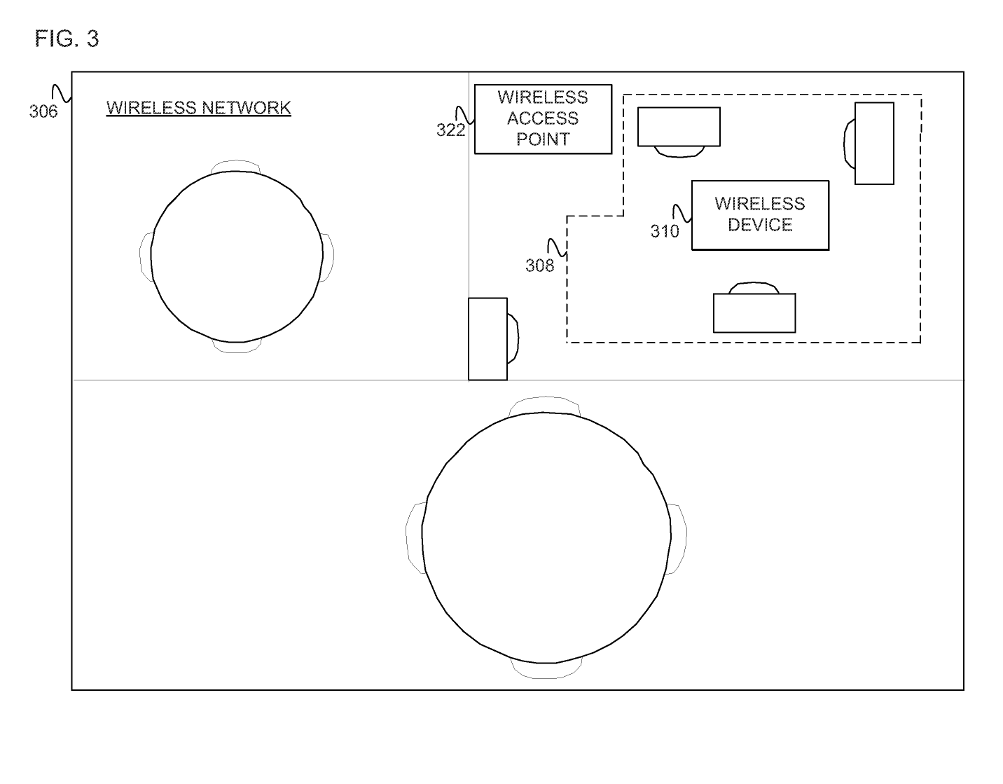

FIG. 3 is a block diagram of an example wireless network 306 including a perimeter 308 illustrating a logical model of a physical site to define a perimeter 308 to monitor a wireless device 310 for limited movement within this area 308. Specifically, FIG. 3 is logical model (i.e., visual map) of a physical site depicting the wireless network 306 divided into three rooms with circles (i.e., tables) and rectangles (i.e., desks). The administrator may use this logical model to define the boundaries of the perimeter 308. Although FIG. 3 depicts the wireless network 306 in a configuration as divided into three rooms, embodiments should not be limited to this illustration as the wireless network 306 may be arranged into any number of configurations. For example, the wireless network 306 may include one large room or several smaller rooms. The wireless network 306 may be similar in structure and functionality of the wireless network 106 and 206 as in FIGS. 1-2, respectively.

The perimeter 308 is defined as the area to restrict movement of the wireless device 310. The perimeter 308 may be defined without regard to the physical structure of the surroundings in the wireless network 306. For example, the perimeter 308 may include a shared area with three desks to track the wireless device 310 among this perimeter 308, while not including the single desk at the in the left hand corner of the top right room as part of the perimeter 208. In a further example, the wireless device 310 may be restricted to a stationary position, thus the perimeter 308 may be defined as being much smaller in space encompassing a single desk. The perimeter 308 may be similar in structure and functionality of the perimeter 108 and 208 as in FIGS. 1-2, respectively.

The wireless device 310 is tracked within the perimeter 308 at the top right room in the wireless network 306. In one embodiment, the location of this wireless device as within the perimeter 308 may be rendered on the display. For example, the wireless device 310 may be rendered on the display as within the perimeter 308 between the desks. In another example, the wireless device 310 may be rendered as closer to the table at the bottom of the figure. In this example, a violation of the perimeter 308 may occur if the perimeter 308 was defined as encompassing the three desks. In another embodiment, once the violation of the perimeter 308 occurs, a notification or triggering event may be transmitted. For example, the wireless device 310 may include a device managed by the computing device 102 within the wireless network 106 and as such, when this device leaves the perimeter 108, the wireless network 106 may disable the functionality. The wireless device 310 may be similar in structure and functionality of the wireless device 110 and 210 in FIGS. 1-2, respectively.

The wireless access point 322 receives a signal from the wireless device 310 to transmit to a computing device. Additionally, the wireless access point 322 may be located any number of locations within the wireless network 306. The wireless access point 322 may be similar in structure and functionality of the wireless access point 222 as in FIG. 2.

FIG. 4 is a block diagram of an example computing device 400 for defining a perimeter to monitor a wireless device for a violation of the perimeter. Further, the example computing device 400 may transmit a notification and/or trigger an event. The notification may include at least one of: an email, visual representation, text message, and/or administrator configured option. The trigger event may include at least one of a deny access to the wireless device for service within a wireless network and/or disable a functionality of the wireless device. Although the computing device 400 includes processor 402 and machine-readable storage medium 404, it may also include other components that would be suitable to one skilled in the art. For example, the computing device 400 may include the display 224 as in FIG. 2. Additionally, the computing device 400 may be similar in structure and functionality of the computing devices 102 and 202 as in FIGS. 1-2, respectively.

The processor 402 may fetch, decode, and execute instructions 406, 408, 410, 412, 414, 416, 418, 420, 422, 424, 426, and 428. The processor 402 may be similar in functionality and structure to the processor 104 and 204 as in FIG. 1 and FIG. 2, respectively. Specifically, the processor 402 executes: define a perimeter within the wireless network instructions 406, receive signal data associated with the wireless device instructions 408, detect a location of the wireless device instructions 410, convert the signal data into a coordinate instructions 412, transmit a notification instructions 414, and trigger an event instructions 424. Additionally, the processor 402 may execute instructions to include at least one of the following notifications at instructions 414: email instructions 416; visual representation instructions 418; text message instructions 420; and administrator-configured option instructions 422. Further, the processor 402 may execute instruction to include at least one of the following events at instructions 424: deny access instructions 426; and disable functionality of the wireless device instructions 428.

The machine-readable storage medium 404 may include instructions 406, 408, 410, 412, 414, 416, 418, 420, 422, 424, 426, and 428 for the processor 402 to fetch, decode, and execute. The machine-readable storage medium 404 may be an electronic, magnetic, optical, memory, storage, flash-drive, or other physical device that contains or stores executable instructions. Thus, the machine-readable storage medium 404 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 404 may include an application and/or firmware which can be utilized independently and/or in conjunction with the processor 402 to fetch, decode, and/or execute instructions of the machine-readable storage medium 404. The application and/or firmware may be stored on the machine-readable storage medium 404 and/or stored on another location of the computing device 400.

Instructions 406 define the perimeter within the wireless network as to enable a monitoring of the wireless device for a violation of this perimeter. In one embodiment of instructions 406, an administrator may define the perimeter on a visual illustration depicting the wireless network. In this regard, the administrator may manage the wireless device by restricting areas of movement. This also allows the violation of the perimeter to be defined by restricting an area of movement or specifying the area of which the wireless device is restricted from entering.

Instructions 408 receive the signal data associated with the wireless device. The signal data indicates the location of the wireless device as to determine whether the wireless device has violated the perimeter. In one embodiment, the signal data is received from a wireless access point that receives a signal from the wireless device. In another embodiment, the signal data is received from the wireless device. In this embodiment, the signal data includes the signal. In a further embodiment, the signal data is converted into a coordinate to detect the location of the wireless device.

Instructions 410 detect the location of the wireless device utilizing the signal data received as instructions 408. In one embodiment of instructions 410, the computing device 400 may detect the location of the wireless device by receiving signal data such as signal strength to detect the location. In another embodiment, instructions 410 include instructions 412 to convert the signal data into coordinate(s) to detect the location.

Instructions 412 convert the signal data received at instructions 408 into a coordinate as to detect the location of the wireless device. In this embodiment, the signal data may include the signal strength, frequency, or other type of data enabling the computing device 400 to detect the location of the wireless device and is converted to coordinate(s). Using coordinate(s) for the location of the wireless device, the computing device 400 may compare these coordinate(s) to other coordinate(s) used to define the perimeter at instructions 406 to determine whether the wireless device has violated the defined perimeter.

Instructions 414 transmits a notification once it is determined the wireless device has violated the perimeter at instructions 410. In one embodiment of instructions 414, the notification may be delivered as email at instructions 416, visual representation at instructions 418, text message at instructions 420, and/or administrator configured option at instructions 422.

Instructions 416 transmits email to notify an administrator once the wireless device has violated the perimeter defined at instructions 406. Once detecting the wireless device has violated the perimeter defined at instructions 406, the computing device transmits the email communicating the location of the wireless device. Instructions 418 transmit a visual representation once the wireless device has violated the perimeter defined at instructions 406. Instructions 420 transmits the text message once the wireless device has violated the perimeter defined at instructions 406.

Instructions 422 includes the administrator configured option to be transmitted as notification the wireless device has violated the perimeter defined at instructions 406. In this embodiment, the administrator may set how to receive these notifications. This allows flexibility to the administrator in case communication might be restricted to different types of communication. For example, the administrator may have not have access to a computer and may set to receive the notification as a phone call. In another embodiment, instructions 422, may include a siren notification when the wireless device has violated the perimeter.

Instructions 424 triggers an event once the wireless device has violated the perimeter defined at instructions 406. In this embodiment, the type of wireless device may depend on the type of event triggered at instructions 424. For example, instructions 426 include denying access to the wireless device for service within the wireless network and instructions 428 disable a functionality on the wireless device. Instructions 428 may be programmed on the wireless device managed by the administrator of the wireless network, while a user's personal wireless device may not be able to have the functionality disabled, yet may have access to service within that wireless network denied.

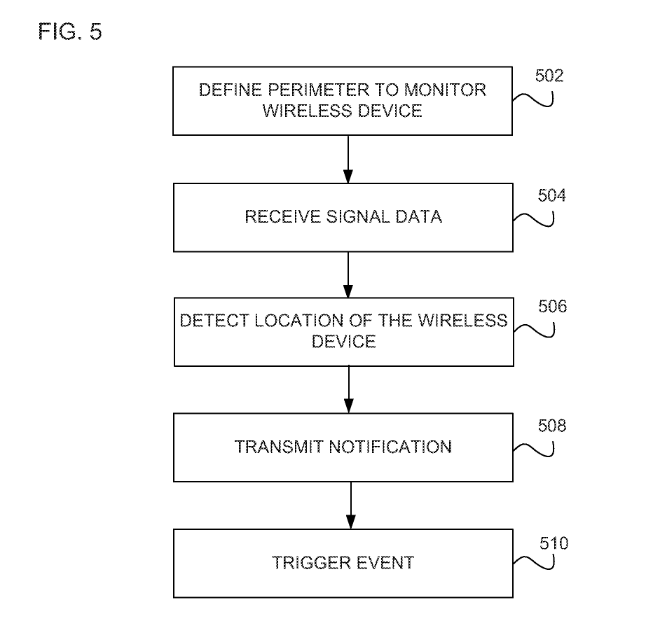

FIG. 5 is a flowchart of an example method performed on a computing device to define a perimeter, receive signal data, and detect a location to determine whether a wireless device has violated the defined perimeter. Although FIG. 5 is described as being performed on computing device 102, 202, and 400 as in FIGS. 1-2, and 4, it may also be executed on other suitable components as will be apparent to those skilled in the art. For example, FIG. 5 may be implemented in the form of executable instructions on a machine-readable storage medium, such as machine-readable storage medium 404 in FIG. 4.

At operation 502 the computing device defines a perimeter within a wireless network to monitor a wireless device for a violation of this defined perimeter. In one embodiment, an administrator may define the perimeter. In this embodiment, the perimeter may be interpreted as coordinates, so the administrator may adjust and readjust the perimeter accordingly. This provides a flexible manner to provide an area restriction on the wireless device. Further, this perimeter may be very small indicating a stationary restriction while the perimeter is larger indicates the wireless device may move around an area. In another embodiment, by defining the perimeter 502 allows an administrator to specifying a violation by defining a restricted area the wireless device from entering or moving outside.

At operation 504 the computing device receives signal data associated with the wireless device. The signal data associated with the wireless device enables the computing device to determine a location of the wireless device. In one embodiment, operation 504 may occur simultaneously with operation 502, while in another embodiment, operation 502 occurs prior to operation 504. In another embodiment, operation 504 may convert the signal data to set of coordinates to determine a location of the wireless device at operation 506.

At operation 506 the computing device detects the location of the wireless device based on the signal data received at operation 504.

At operation 508 the computing device transmits a notification once the computing device determines the wireless device is in violation of the defined perimeter at operation 506. In one embodiment of operation 508, the notification may include at least one of: an email, a visual representation, a text message, and/or an administrator-configured option.

At operation 510 the computing device triggers an event. In one embodiment, the event may include at least one of: a deny access to the wireless device for service within the wireless network and/or a disable a functionality of the wireless device. In another embodiment, the type of event depends on the type of wireless device. For example, the computing device may control and/or manage the wireless device, such as a mobile phone, thus the computing device may disable a functionality of the computing device, such as disconnecting the telecommunication aspect on the wireless device. In a further example, the wireless device may attempt to access the internet from the wireless network. In this example, the wireless device may include a laptop and thus once this laptop violates the perimeter defined at operation 502, the wireless access point may use the laptop address to block access to the internet for the laptop. In a further embodiment, the computing device may perform operation 508 or operation 510, once determining the wireless device is in violation of the perimeter at operation 506. Yet, in a further embodiment, operation 508 may be performed in addition to operation 506.

In summary, example embodiments disclosed herein provide a flexible manner to define a perimeter to restrict an area of movement for the wireless device. This provides an administrator the ability to manage, monitor, and track a wireless device within a restricted area and/or track a borrowed wireless device. Further, it also provides a trigger event and/or notification once the wireless device as an additional security feature to alert and/or provide an action the wireless has violated the defined perimeter.

We claim:

1. A non-transitory machine-readable storage medium encoded with instructions executable by a processor of a computing device, the storage medium comprising instructions to:
define a perimeter within a wireless network to monitor a wireless device for a violation of the perimeter;
receive a signal data associated with the wireless device; and
detect a location of the wireless device based on the signal data to determine whether the wireless device has violated the defined perimeter.

2. The non-transitory machine-readable storage medium of claim 1 further comprising instructions to:
transmit a notification the wireless device has violated the defined perimeter, the notification including at least one of an email, a visual representation, a text message, and an administrator-configured option.

3. The non-transitory machine-readable storage medium of claim 1 further comprising:
trigger an event based on whether the wireless device has violated the defined perimeter, the event including at least one of: deny access to the wireless device for service within the wireless network and disable a functionality of the wireless device.

4. The non-transitory machine-readable storage medium of claim 1 wherein to detect the location of the wireless device is further comprising instructions to convert the signal data into a coordinate to detect the location of the wireless device.

5. The non-transitory machine-readable storage medium of claim 1 wherein the signal data is received from a wireless access point in communication with the wireless device.

6. The non-transitory machine-readable storage medium of claim 1 wherein the violation of the perimeter includes when the wireless device is at least one of: outside of the defined perimeter and inside the defined perimeter.

7. A computing system comprising:
a computing device with a processor to:
define a perimeter within a wireless network to monitor a wireless device for violation of the perimeter;
receive a signal data associated with the wireless device;
identify a location of the wireless device based on the signal data; and
determine whether the wireless device has violated the defined perimeter.

8. The computing system of claim 7 further comprising:
the computing device with a display to render the location of the wireless device.

9. The computing system of claim 7 further comprising:
a wireless access point within the wireless network to:
receive a signal from the wireless device; and
transmit the signal data associated with the wireless device to the computing device.

10. The computing system of claim 7 wherein the computing device with the processor is further to transmit a notification the wireless device has violated the defined perimeter.

11. The computing system of claim 7 wherein the computing device with the processor is further to trigger an event based on whether the wireless device has violated the defined perimeter, the event dependent on a type of the wireless device.

12. A method executed by a computing device, the method comprising:
defining a perimeter within a wireless network to monitor a wireless device for a violation of the perimeter;
receiving a signal data associated with the wireless device; and
detecting a location of the wireless device based on the signal data to determine whether the wireless device has violated the defined perimeter.

13. The method of claim 12 further comprising at least one of:
transmitting a notification the wireless device has violated the defined perimeter, the notification; and
triggering an event based on whether the wireless device has violated the defined perimeter, the event dependent on a type of the wireless device

14. The method of claim 12 wherein the signal data is received from a wireless access point and further comprising:
converting the signal data to a coordinate to detect the location of the wireless device.

15. The method of claim 12 wherein the perimeter is defined by coordinates.
